(19) United States
(12) Patent Application Publication
(10) Pub. No.: US 2010/0259933 A1
(43) Pub. Date: Oct. 14, 2010

(54) Cluster Lamp having Wire with Meshed Layer

(76) Inventor: Wen-Tzu WANG, Yuanlin Township (TW)

Correspondence Address: HDLS IPR Services, PO Box 220746, Chantilly, VA, 20153, US

(21) Appl. No.: 12/422,236

(22) Filed: Apr. 10, 2009

(51) Int. Cl. F21S 4/00

(52) U.S. Cl. 362/249.06

(57) ABSTRACT

A cluster lamp having a wire wrapped with a meshed layer mainly includes the wire and a plurality of luminous bodies. The wire includes the meshed layer wrapped around an insulation layer formed on the outside of the wire, the wire protrudes from meshes of the meshed layer to expose a portion of the wire to be cascaded with a plurality of luminous bodies, and each luminous body is lit through contacts with the exposed portion of the wire; wherein the meshed layer provides insulation to the wire and strengthen the anti-twisting and tensile capabilities of the wire.

### BACKGROUND OF THE INVENTION

1. Field of the invention

The present invention relates to a cluster lamp having a wire wrapped with a meshed layer, and more particularly, to a cluster lamp having a wire wrapped with a meshed layer to enhance the tensile strength of the wire and to form a cluster lamp structure with high tensile strength.

2. Description of the Related Art

The cluster lamp structure described in the present invention comprises a plurality of lamps or LEDs cascaded to provide illumination, warning or decoration functions based on the flashing, color or brightness of the different lamps. For example, common Christmas cluster lamps exploit the above structure to light up the streets during Christmas holidays.

The Christmas cluster lamps comprises a plurality of lamps or LEDs cascaded through a wire, when in use, an additional guard wire is preferably provided to prevent the wire breaking off from the lamp when the wire is being dragged, pulled or wound. However, the traditional Christmas lamp uses ordinary wire as the guard wire, which is susceptible to pull and drag motions, lease refer to Attachment 1; Attachment 2 shows the guard wire being pulled out from the socket; Attachment 3 shows a second embodiment of the prior art Christmas cluster lamp, wherein the guard wire is wound on the wire in a spiral; Attachment 4 shows the spirally wound guard wire being pulled out from its original position, at then the guard wire can't prevent the wire breaking off from the socket; therefore, the prior art socket for Christmas cluster lamp is very likely to get damaged.

Besides, it is hard to inspect the traditional Christmas cluster lamps since they can have various numbers of lamps or LEDs, ranging from tens to hundreds; Furthermore, when there are more than one string of Christmas cluster lamps winding together, it is difficult to check or repair the traditional Christmas cluster lamps as well. Even more, it is difficult to notice the damage on the wire when the wire is torn or being pulled out of the insulation layer and still operates normally.

Therefore, the traditional cluster lamps still present some shortcomings to be overcome.

In view of this, the inventor of the present invention has put a lot of efforts in studying the deficiencies in the traditional cluster lamps; after years of constant research, the inventor has proposed a cluster lamp having a wire wrapped with a meshed layer in the present invention.

### SUMMARY OF THE INVENTION

It is an object of the present invention to provide a cluster lamp having a wire wrapped with a meshed layer, which provides excellent tensile strength to protect the wire cascading luminous bodies from breaking off or damaging by dragging or pulling.

It is another object of the present invention to provide a cluster lamp having a wire wrapped with a meshed layer; the tight structure of the meshed layer can provide excellent protection.

To achieve the above objects, the present invention discloses a cluster lamp having a wire wrapped with a meshed layer, which comprises:

the wire comprising the meshed layer, the wire comprising the meshed layer wrapped around an insulation layer formed on the outside of the wire, a portion of the wire protruding from a mesh of the meshed layer;

a plurality of sockets cascaded with a protruded portion of the wire, the plurality of sockets coupling with the wire through conductors piercing through the insulation layer; and

a luminous body coupled with the socket through contacts,

wherein the wire goes through the mesh to be cascaded with the luminous body, so the wire and the luminous body are connected as a whole, while the meshed layer can enhance the tensile strength of the wire.

### BRIEF DESCRIPTION OF THE DRAWINGS

The drawings disclose an illustrative embodiment of the present invention, which serves to exemplify the various advantages and objects hereof, and are as follows:

FIG. 1 illustrates a view of a cluster lamp having a wire wrapped with a meshed layer in the present invention;

FIG. 2 illustrates a partially enlarged view of A section in FIG. 1;

FIG. 3 illustrates a partially enlarged view of B section in FIG. 1;

FIG. 4 illustrates a view of the wire and the insulation layer protruding out of a mesh of the meshed layer;

FIG. 5 illustrates a partially enlarged view of C section in FIG. 4;

FIG. 6 illustrates a view of the wire cascading with a plurality of sockets and luminous bodies;

FIG. 7 illustrates a partially enlarged view of D section in FIG. 6;

FIG. 8 illustrates a view of the cluster lamp having the wire wrapped with the meshed layer, in which the luminous body protruding from the mesh is protected when the wire is pulled out;

FIG. 9 illustrates a partially enlarged view of E section in FIG. 8;

Attachment 1 shows a first embodiment of a prior art Christmas cluster lamp, in which a wire coupling with the lamp and a guard wire are shown;

Attachment 2 shows the guard wire in Attachment 1 being pulled out from the socket;

Attachment 3 shows a second embodiment of the prior art Christmas cluster lamp, wherein the guard wire is wound on the wire in a spiral;

Attachment 4 shows the spirally wound guard wire being pulled out from its original position, at then the guard wire can't prevent the wire breaking off from the socket; and

Attachment 5 shows the cluster lamp in the present invention, wherein the portion of the wire protruding out of the mesh is coupled with the luminous body, meanwhile the meshed layer can protect the protruded portion of the wire with high tensile strength.

### DETAILED DESCRIPTION OF THE PREFERRED EMBODIMENT

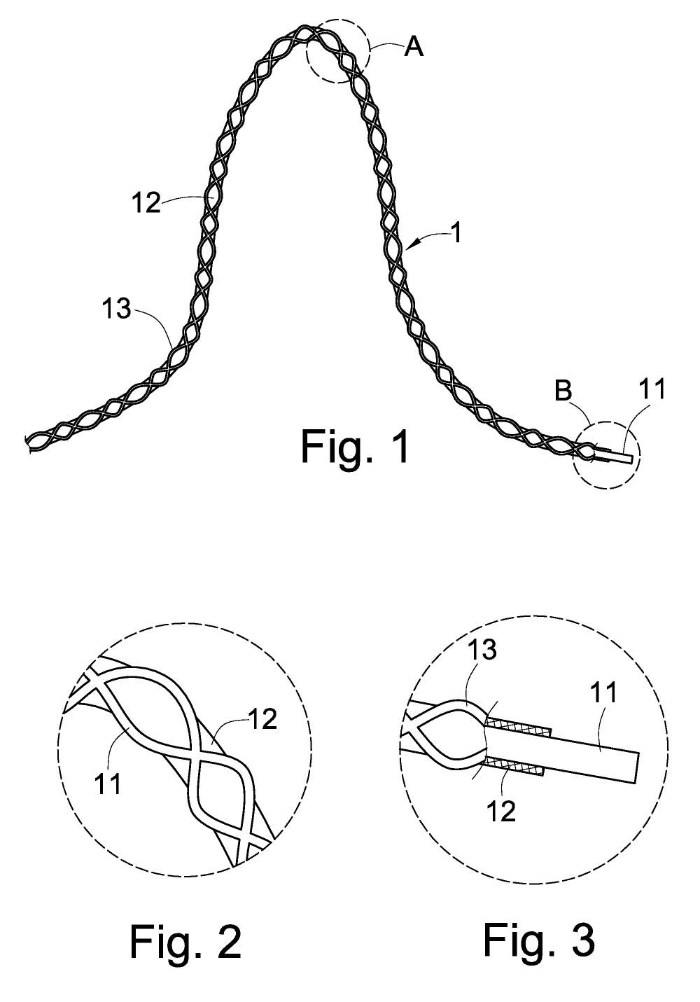

Please refer to FIG. 1 to FIG. 5 and Attachment 5 for a first embodiment of a cluster lamp having a wire 1 wrapped with a meshed layer 13, which mainly comprises the wire 1 comprising the meshed layer 13 and a plurality of luminous bodies 2.

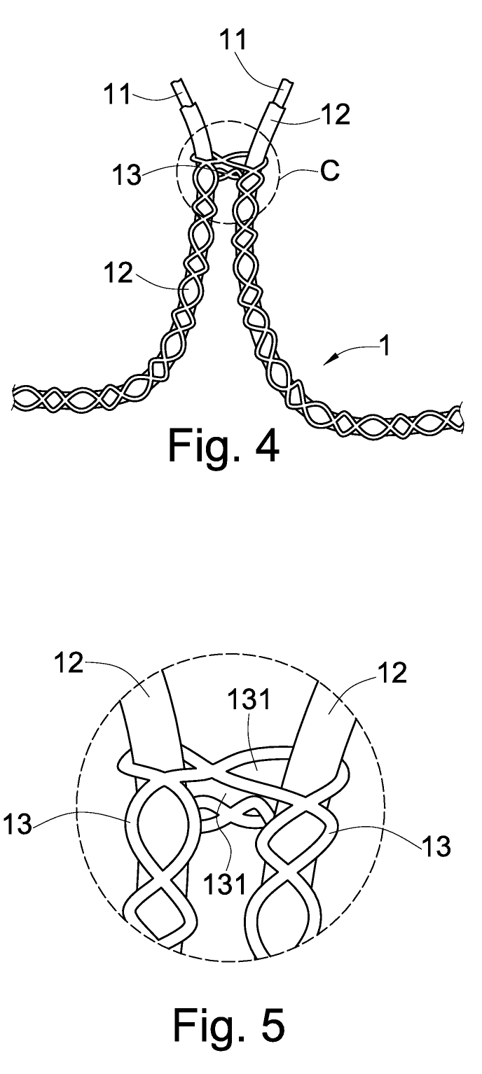

The wire 1 comprises the meshed layer 13 wrapped around an insulation layer 12 formed on the outside of a single-core conducting wire 11, the wire protrudes from a mesh 131 to expose a portion of the conducting wire 11 (as shown in FIG. 4 and FIG. 5); wherein the meshed layer 13 is plaited with thread or polymer to provide excellent tensile strength and insulation; the meshed layer 13 is plaited with 2 strands of semi-finished product to form a tight structure.

The plurality of sockets 3 is cascaded with the portion of the wire 1 protruding from the mesh 131, the socket 3 couples with the conducting wire 11 of the insulation layer 12 through a conductor.

The luminous body 2 electrically couples with the conducting wire 11 via a contact 21.

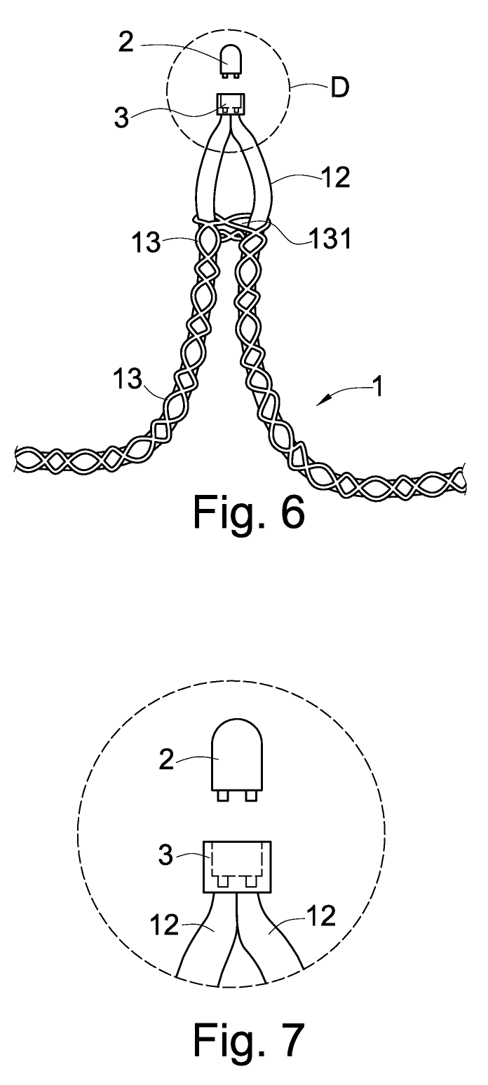

Please refer to FIG. 6 and FIG. 7, where the conducting wire 11 of the wire 1 protruding from the mesh 131 is cascaded with a plurality of socket 3, so the luminous body 2 can be electrically coupled with the socket 3 via the contact 21, power from the wire 1 is transmitted via the socket 3 to the luminous body 2 to light up the luminous body 2.

The second embodiment of the present invention discloses a wire 1 comprising a meshed layer 13 wrapped around an insulation layer 12 formed on the outside of the conducting wire 11, the wire 1 protruding from a mesh 131 of the meshed layer 131; and a luminous body 2 coupled with a conducting wire 11 via contacts 21 piercing through an insulation layer 12. What is different from the first embodiment is that no conducting wire 11 is exposed from the wire 1 protruding out of the mesh 131, when the wire 1 protrudes out of the mesh 131, the luminous body 2 is coupled with the conducting wire 11 via the contacts 21 piercing through the insulation layer 12, therefore the wire 1 can directly transmit power to the luminous body 2 to light up the luminous body 2.

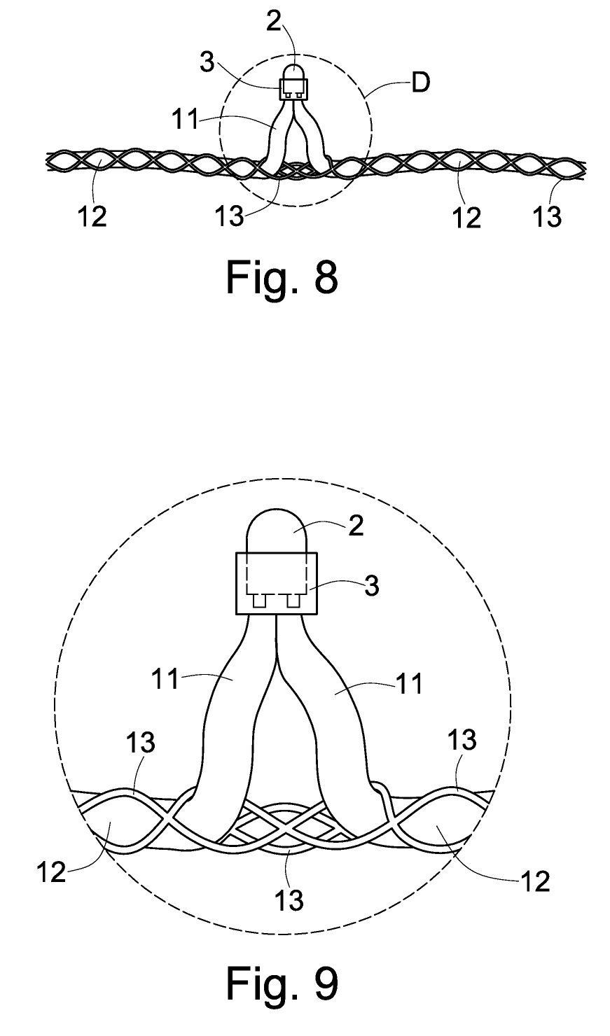

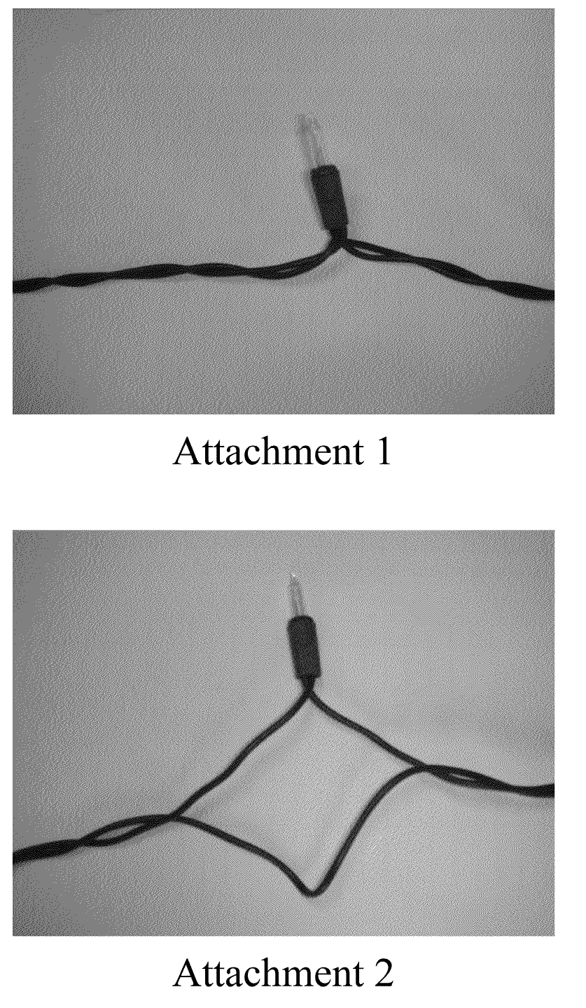

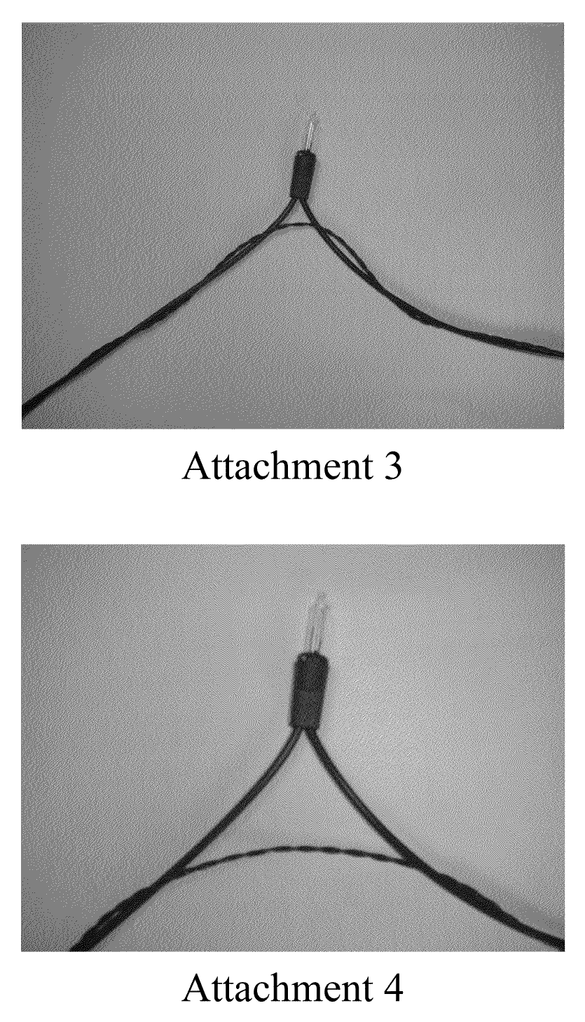

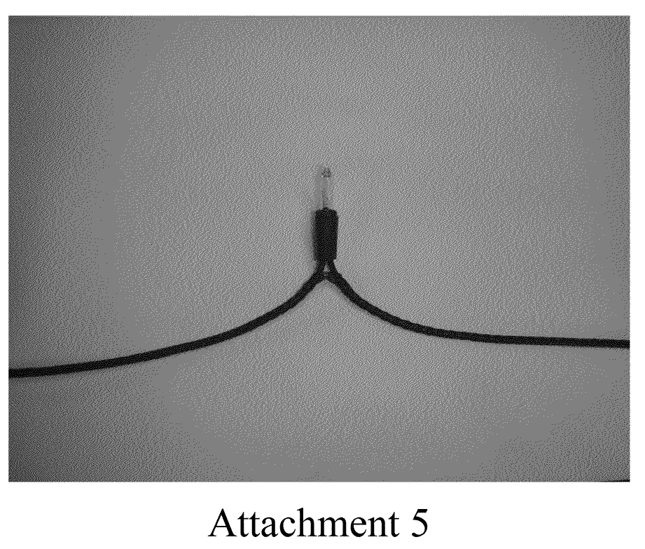

As described above, the wire 1 is wrapped with the whole meshed layer 13 to provide high tensile strength, as shown in FIG. 8 and FIG. 9, since the wire is exposed to be coupled with the luminous body 2, the portion of the wire coupling with the luminous body 2 protrudes from the mesh 131 of the meshed layer 13, while other portions of the meshed layer 13 are still integrated. The meshed layer 13 is soft and flexible to allow bending or twisting of the wire 1; besides, the meshed layer 13 can completely wrap around the insulation layer 12 of the wire to protect the wire.

Furthermore, when the user has set up the cluster lamp, he/she can choose where to pull out the wire 1 from the mesh 131 of the meshed layer 13 and to couple with the luminous body 2. The cluster lamp having the wire 1 wrapped with the meshed layer 13, while compared with the traditional cluster lamp, is advantageous in:

(1) The meshed layer disclosed in the present invention can prevent the wire breaking off or being damaged when the wire is being pulled or twisted. Therefore, the user can freely use the cluster lamp for decoration without worrying the cluster lamp might fail to flash.

(2) The meshed layer disclosed in the present invention can isolate the conducting wire from the outside to prevent short circuit even when the conducting wire is exposed by external force, thereby reducing the possibility of accidents.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A cluster lamp having a wire wrapped with a meshed layer, comprising:
the wire comprising the meshed layer wrapped around an insulation layer formed on the outside of the wire, the wire protruding from a mesh of the meshed layer to expose a portion of the wire; and
a luminous body cascading with the wire, wherein the luminous body is lit through contacts with the exposed portion of the wire.

2. The cluster lamp having the wire wrapped with the meshed layer as claimed in claim 1, wherein the meshed layer is plaited with thread or polymer to provide excellent tensile strength and insulation.

3. The cluster lamp having the wire wrapped with the meshed layer as claimed in claim 1, wherein the portion of the wire protruding from the mesh of the meshed layer is cascaded with a plurality of sockets to be electrically coupled with the contacts of the luminous body for lighting up the luminous body.

4. A cluster lamp having a wire with a meshed layer, comprising:
the wire comprising the meshed layer wrapped around an insulation layer formed on the outside of the wire, the wire protruding from a mesh of the meshed layer; and
a luminous body coupled with the wire via contacts piercing through the insulation layer.

5. The cluster lamp having the wire wrapped with the meshed layer as claimed in claim 4, wherein the meshed layer is plaited with thread or polymer to provide excellent tensile strength and insulation.

6. A cluster lamp having a wire wrapped with a meshed layer, comprising:
the wire comprising the meshed layer wrapped around an insulation layer formed on the outside of the wire, a portion of the wire protruding from a mesh of the meshed layer;
a plurality of sockets cascaded with a protruded portion of the wire, the plurality of sockets coupling with the wire through conductors piercing through the insulation layer; and a luminous body coupled with the socket through contacts.
